(19) United States
(12) Patent Application Publication
(10) Pub. No.: US 2002/0011681 A1
(43) Pub. Date: Jan. 31, 2002

(54) Process and device for controlling the molding of a container

(76) Inventors: Peter Rose, Hamburg (DE); Willi Predohl, Elmenhorst-Fischbek (DE)

Correspondence Address: HARNESS, DICKEY & PIERCE, PLC, P.O. BOX 828, BLOOMFIELD HILLS, MI, 48303, US

(21) Appl. No.: 09/811,281

(22) Filed: Mar. 16, 2001

Related U.S. Application Data
(63) Continuation of application No. PCT/DE99/02904, filed on Sep. 9, 1999.

(30) Foreign Application Priority Data
Sep. 19, 1998 (DE) 198 43 053.1

(51) Int. Cl. B29C 49/06; B29C 49/16; B29C 49/36; B29C 49/78

(52) U.S. Cl. 264/40.1; 264/40.3; 264/529; 264/532; 264/521; 264/538; 425/135; 425/526; 425/530; 425/540

(57) ABSTRACT

The process and device are intended for controlling the molding of a container during the manufacture of containers from a thermoplastic material. At least two previously injection-molded preforms are temperature-treated and delivered in succession to at least one blow station for blow molding of the preforms into containers. In order to compensate for nonuniform temperature distribution in the material of the preforms relative to one another, at least one blow parameter during molding of the preforms into containers is specified in a fashion that differs from one to the next. The differing specification is made in such a manner as to compensate for the nonuniform temperature distribution so that containers with approximately identical spatial distribution of wall material, orientation properties, and crystallization characteristics exist when the blow-molding process is finished.

### CROSS REFERENCE TO RELATED APPLICATION

This application is a continuation of PCT/DE99/02904.

### BACKGROUND AND SUMMARY OF THE INVENTION

The invention relates to a process for controlling the molding of a container during the manufacture of containers from a thermoplastic material, in which at least two previously injection-molded preforms are temperature-treated and delivered in chronological succession to at least one blow station for blow molding of the preforms into containers.

The invention additionally relates to a device for blow molding of containers from a thermoplastic material that has a temperature treatment unit for injection-molded preforms, at least one stretching unit for the preforms, as well as at least one blow station for molding the preforms into containers.

Processes and devices of this nature are used to deliver preforms of a thermoplastic material, for example preforms of PET (polyethylene terephthalate), to different processing stations within a blow molding machine. Typically, such a blow molding machine has a heater unit and a blow unit, in the vicinity of which the previously temperature treated preform is expanded by biaxial orientation into a container. The expansion is accomplished with the use of compressed air, which is introduced into the preform to be expanded. The process sequence of such an expansion is explained in DE-OS 4,340,291. The device can also be used to remove completed blow-molded containers from the blow unit and to transport them further.

The basic structure of a blow station for molding containers is described in DE-OS 4,212,583. Options for temperature treatment of the preforms are explained in DE-OS 2,352,926.

Within the device for blow molding, the preforms and the blow-molded containers can be transported by means of various handling devices. One proven technique in particular is the use of transport mandrels onto which the preforms are placed.

The preforms can also be handled with other carrying devices, however. For example, the use of grippers for handling preforms is described in FR-OS 2,720,679. An expansion mandrel that can be introduced into a mouth of the preform is explained in WO 9,533,616.

The aforementioned handling of the preforms takes place as part of the so-called two-stage process, in which the preforms are first manufactured in an injection molding process, then are stored temporarily, before later being conditioned with respect to their temperature and blow molded into containers. Application is also found in the so-called one-stage process, in which the preforms are temperature treated and then blow molded immediately after their production by injection molding and adequate hardening.

As regards the blow stations employed, various different designs are known. In blow stations that are arranged on rotating transport wheels, one frequently encounters mold supports that swing open in a book-like fashion.

In stationary blow stations, which are especially suitable for accommodating multiple cavities for container molding, plates that typically are arranged parallel to one another are used as molds.

In the manufacture of containers by blow molding, efforts are generally made to produce containers which all have a high uniformity of material distribution, orientation properties and degree of crystallization from container to container. In blow-molding machines in which several preforms are simultaneously blow molded within one blow station, the problem arises that there can be differences in temperature distribution among the preforms, since the preforms are processed at the same time in the blow station but were not simultaneously influenced beforehand with regard to temperature to compensate for the thermal differences.

A comparable problem also arises in the one-stage process when a certain number of preforms are first produced simultaneously by injection molding and subsequently provided with a temperature profile, but subsets of these preforms are then processed sequentially during blow molding of the containers. As a result of the time interval between the processing of the subsets, differences in the heat content of the preforms can arise.

Consequently, the object of the present invention is to improve a process of the aforesaid type so as to support production of containers with uniform material properties.

This object is attained in accordance with the invention in that, to compensate for nonuniform heat content in the material of the preforms relative to one another, at least one blow parameter during molding of the preforms into containers is specified in a fashion that differs among them in such a manner as to compensate for the nonuniform heat content so that containers with approximately identical spatial distribution of wall material, orientation properties, and crystallization characteristics exist when the blow-molding process is finished.

It is a further object of the invention to design a device of the aforementioned type such that uniform container production is supported.

This object is attained in accordance with the invention in that parameter control is provided which specifies at least one of the parameters influencing the molding process differently from one preform to the next for at least two preforms processed in succession.

The differing specification of at least one blow parameter takes into account that the material properties of the end product are a function of a number of factors which interact with one another. Thus if, as a result of production conditions that cannot be influenced, nonuniform temperature distributions arise among the preforms to be processed, suitably influencing the blow molding process can as a general rule compensate for, or at least reduce, the differences which would otherwise arise in the manufactured containers due to the uneven temperature distribution or the differing heat content if no additional counter-measures were taken.

It is useful to select the particular parameter of influence in accordance with an analysis of the temperature treatment differences arising in the preforms in the absence of additional influences. Blow parameters acting in the vicinity of the blow station can be changed as well as parameters encountered before the preforms are delivered to the blow station. What is meant here in particular is heating of the preforms or targeted influencing of the cooling process. Depending on the requirements at hand, one or more blow parameters can be adopted.

In the case of known, process-related and constantly recurring differences in the properties of the preforms to be processed, it is possible to specify the differing blow parameters through control alone. It is fundamentally also possible to specify the differing parameters as a function of a measurement performed with regard to at least one property of the preform, or adaptively using measurement and processing of at least one property of the manufactured container.

An abundance of options for influencing the blow process is provided in that the blow molding is performed as a sequence of an initial preblow phase followed by a primary blow phase, wherein a higher blow pressure is achieved during the primary blow phase than is reached during the preblow phase, and in that the pressure profile is varied as a blow parameter.

A simple method of influencing the process is supported by varying the duration of the preblow phase as a blow parameter.

It is likewise proposed to vary the duration of the primary blow phase as a blow parameter.

Another possibility is to vary the time of switchover between the preblow phase and the primary blow phase as a blow parameter.

A further method of influence is defined in that the stretching rate is varied as a blow parameter.

Finally, it is also possible to vary the start time of the stretching process as a blow parameter.

A possibility for exerting influence before delivering the preforms to the blow station is provided in that differing thermal treatment of successive preforms is carried out in such a manner that an approximately identical temperature distribution is present in the preforms despite the differences among the individual preforms in the waiting period prior to blow molding and/or prior to a heating phase preceding blow molding.

Another variant resides in that essentially identical thermal treatment of the successive preforms is carried out initially and this identical thermal treatment is followed by an additional thermal treatment that approximately compensates for the differences in waiting period among the individual preforms prior to the start of subsequent blow molding.

A typical area of application is defined in that an application is carried out in one-stage manufacture of the containers.

A typical application in carrying out the one-stage process consists in that N preforms are first produced simultaneously by injection molding, and then X×M preforms are simultaneously molded into containers, where X×M=N.

As an alternative to deterministic control, it is also possible that control of the change in at least one blow parameter is performed as a function of measurement of at least one property of the preforms.

### BRIEF DESCRIPTION OF THE DRAWINGS

Example embodiments of the invention are represented schematically in the drawings.

FIG. 1: shows a perspective view of a blow station for manufacturing containers from preforms;

FIG. 2: shows a longitudinal section through a blow mold in which a preform is stretched and expanded;

FIG. 3: is a sketch to illustrate a basic structure of a device for blow molding of containers, and

FIG. 4: shows the elementary structure of a blow-molding module of a device for performing the one-stage process.

### DESCRIPTION OF THE PREFERRED EMBODIMENT

The process and the device can find application in both one-stage and two-stage manufacture of containers. Heating or heat-conditioning of a preform (1) prior to the orientation process can be accomplished in a number of different ways. When a tunnel-like heating section is used, temperature treatment occurs solely as a function of the dwell time. However, it is also possible to use radiant heaters that subject the preform (1) to infrared or high frequency radiation. With the use of such radiant heaters it is possible to create a temperature profile along the longitudinal axis in the vicinity of the preform (1).

If such a radiant heater is composed of several heat elements that can be controlled independently of one another and that are stacked in the direction of a longitudinal axis of the preform (1), more intense activation of the heat elements in the region of the upper extension of the preform (1) toward the mouth section can cause more heat energy to be radiated in the thickened region of the wall section than in the region of the wall section which faces the bottom. In the case of radiant heaters that can only be activated uniformly, heat profiling of this nature can also be achieved through an arrangement of the heating elements spaced at different intervals along the longitudinal axis.

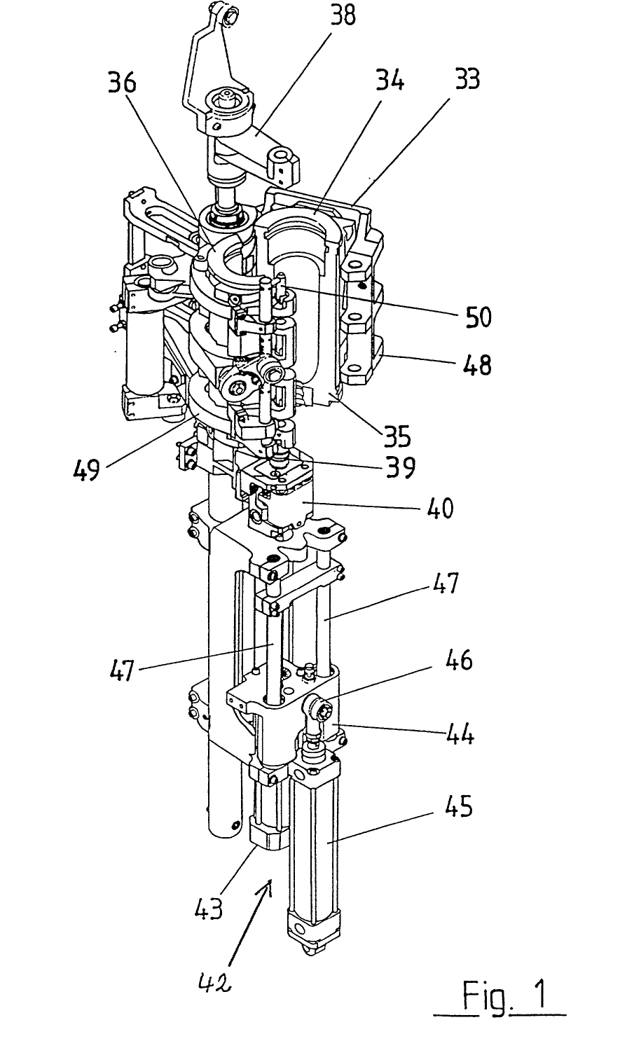

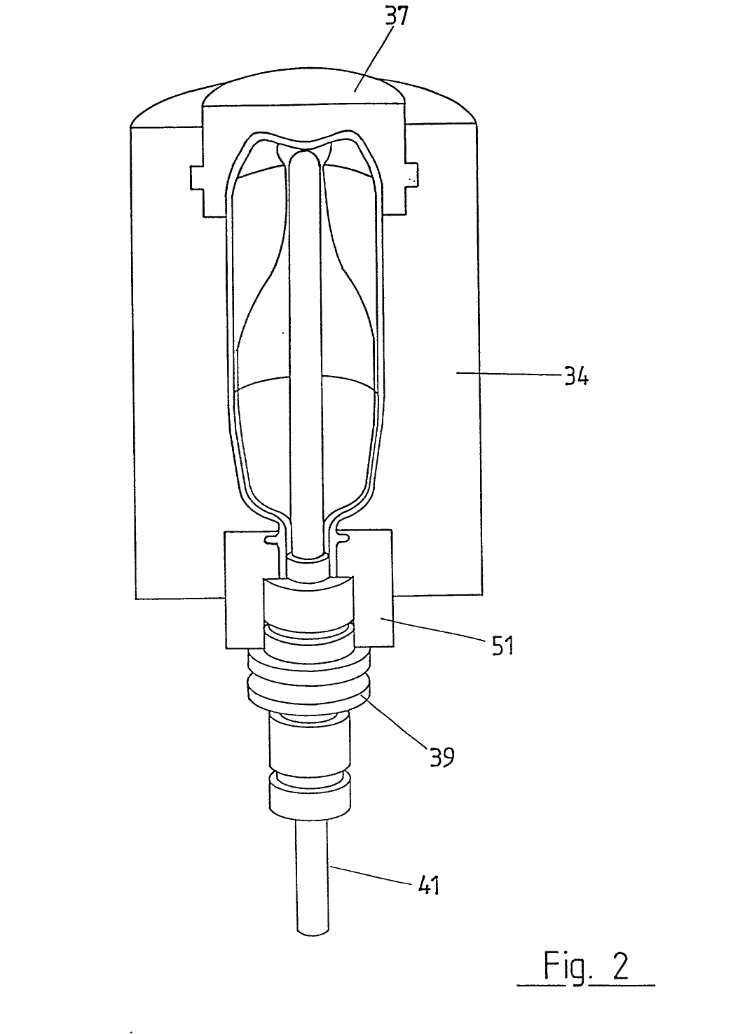

The basic structure of a device for blow molding the preforms (1) into containers (13) is shown in FIG. 1 and FIG. 2.

The device for forming the container (13) consists essentially of a blow station (33), which is equipped with a blow mold (34) into which can be inserted a preform (1). The preform (1) can be an injection-molded part of polyethylene terephthalate. To permit insertion of the preform (1) in the blow mold (34) and to permit removal of the finished container, the blow mold (34) is composed of mold parts (35, 36) and a bottom piece (37) that can be positioned by a lifting apparatus (38). The preform (1) can be held in the area of the blow station (33) by a transport mandrel (39), which passes through a plurality of treatment stations along with the preform (1). However, it is also possible to insert the preform (1) directly in the blow mold (34) through the use of grippers, for example, or other handling means.

To permit the delivery of compressed air, a connecting flask (40) is arranged beneath the transport mandrel (39); this flask supplies compressed air to the preform (1) and simultaneously provides sealing relative to the transport mandrel (39). In a modified design, it is also possible to use fixed compressed air lines, of course.

Stretching of the preform (1) is accomplished with the aid of a stretching rod (41), which is positioned by a cylinder (42). However, it is also possible to accomplish mechanical positioning of the stretching rod (41) by means of cam segments acted upon by follower rollers. The use of cam segments is particularly useful when a plurality of blow stations (33) are arranged on a rotating blow wheel. Use of cylinders (42) is useful when stationary blow stations (33) are provided.

In the embodiment shown in FIG. 1, the stretching system is designed such that a tandem arrangement of two cylinders (42) is provided. Before the start of the actual stretching process, the stretching rod (41) is first moved by a primary cylinder (43) into the region of the bottom (7) of the preform (1). During the actual stretching process, the primary cylinder (43) with extended stretching rod is positioned, together with a carriage (44) bearing the primary cylinder (43), by a secondary cylinder (45) or via a cam control. In particular, the intent is to use cam control of the secondary cylinder (45) in such a way that a current stretching position is given by a guide roll (46), which slides along a curved path during the stretching process. The guide roll (46) is pressed against the guide path by the secondary cylinder (45). The carriage (44) slides along two guide elements (47).

After the mold parts (35, 36) in the vicinity of supports (48, 49) have closed, the supports (48) lock relative to one another by means of a locking device (50).

In order to adjust to various shapes of the mouth section (2), provision is made to use separate thread inserts (51) in the area of the blow mold (34), as shown in FIG. 2.

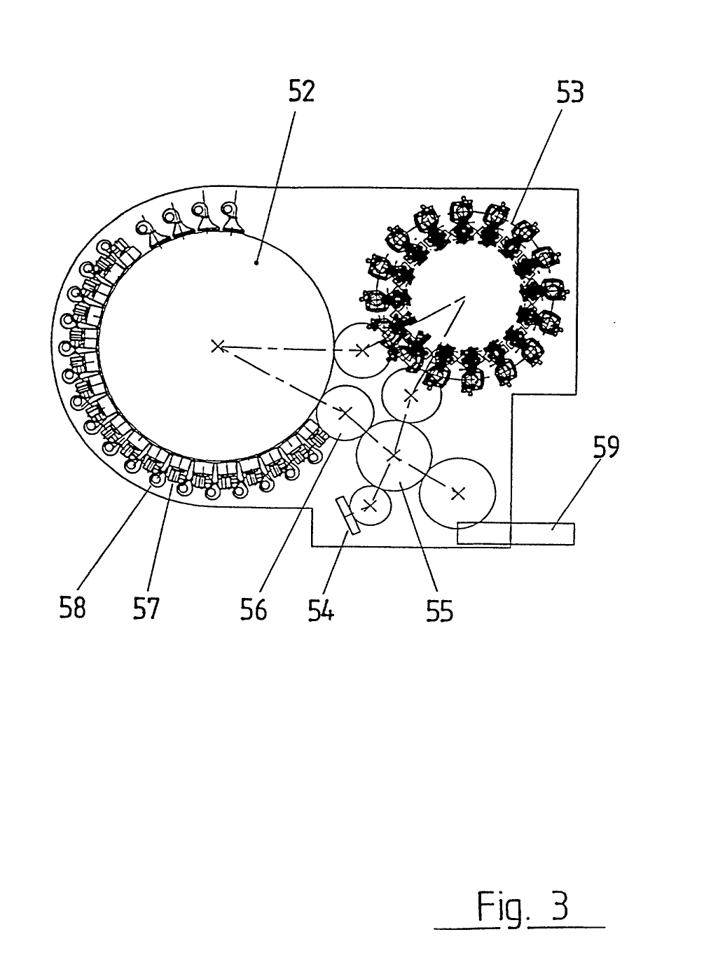

FIG. 3 shows the basic structure of a blow molding machine that is equipped with a rotating heat wheel (52) as well as a rotating blow wheel (53). Starting at a preform inlet (54), the preforms (1) are transported by transfer wheels (55, 56) into the area of the heat wheel (52). Arranged along the heat wheel (52) are radiant heaters (57) and fans (58) for temperature treatment of the preforms (1). After sufficient temperature treatment of the preforms (1), they are transferred to the blow wheel (53); the blow stations (33) are arranged near the latter. The finished, blow molded containers (13) are delivered to an output section (59) by additional transfer wheels.

To be able to mold a preform (1) into a container (13) in such a way that the container (13) has material properties that ensure a long shelf life of foods, more particularly beverages, placed in the container (13), special process steps must be followed during the heating and orientation of the preforms (1). More-over, beneficial effects can be achieved by adhering to special dimensioning guidelines.

A variety of plastics can be used as the thermoplastic material. Examples of plastics that may be used include PET, PEN and polypropylene.

Expansion of the preforms (1) during the orientation process is accomplished through the delivery of compressed air. The delivery of compressed air is divided into a preblow phase, in which gas, for example compressed air, is delivered at a low pressure level, and a subsequent primary blow phase, in which gas is delivered at a higher pressure level. Typically, compressed air at a pressure in the range from 10 bar to 25 bar is used during the preblow phase, and compressed air at a pressure in the range from 25 bar to 40 bar is used during the primary blow phase.

Influencing the blow parameters to even out the properties of the manufactured containers can be accomplished in various ways. For example, it is possible to vary the time when the blow pressure is applied for the preblow phase. Likewise, it is possible to adapt the maximum effective pressure during the preblow phase. Another possibility is to vary the volume flow of blow air during the preblow phase.

Yet another possibility for parameter influence consists in changing the length of time between the start of the stretching process and the start of the preblow process. Finally, it is also possible to adapt the start time for the primary blow phase and the maximum pressure in effect during the primary blow phase.

Prior to delivering the preforms to the blow station, it is possible to influence the temperature profile within the preforms as well as their individual heat content. For example, if the preforms are first temperature-treated continuously, but then at least two preforms are subsequently molded into containers at the same time, it is possible to compensate for the nonuniform heat content in the material of the preforms relative to one another resulting from the continuous heating by exerting targeted influence on the preforms before starting the blow-molding step. The targeted influence can be a heating process, a cooling process, or a combination of heating and cooling.

It is also possible when performing the one-stage process not only to influence parameters in the area of the blow station, but also to influence parameters in the pre-stages before the blow molding step, in order to compensate for uneven heat content or heat distribution due to different waiting periods for the blow molding step or reheating. The objective here is to at least reduce the nonuniformities. In this case as well, we propose targeted influence of, for example, the temperature profile through heating, cooling, or a combination of heating and cooling.

In one-stage blow molding machines, the plastic granulate (resin) is melted by a heated worm screw and injected under high pressure into an injection mold to produce preforms. The injection mold has, for example, 8×cavities arranged in a row. After cooling of the melt to approximately 130° C. to 150° C., the preforms are transferred to a transport device, for example a chain with preform holders. The transferred preforms have a material temperature of approximately 120° C. to 130° C. After further cooling, the warm preforms (100° C. to 110° C.) are transferred to a blow station (for example, with 2×blow molds in a row) where they are blown into plastic containers, molded and cooled. Blow-molding and cooling of the plastic containers has a process time that is considerably shorter as compared to the cycle time of the injection molding process. The injection molding process is approximately 5 to 8 times longer than the blow molding process time.

High quality plastic containers can be produced especially when the preforms are processed cyclically, which is to say in groups, in order to achieve the same temperature build-up in each preform. As a result of the temperature-stable transfer by groups of the preforms to the blow station, the production output of the one-stage blow machines is limited by the injection molding process.

If the preforms are transferred to the blow station in pairs, for example, the production output for a group of, for example, 8×preforms is 4 times greater. In this case, however, one has the problem that the preforms transferred serially to the blow station differ in temperature distribution in the absence of compensation measures. This has the effect that each of the subgroups develops differently in the blow molding process as a result of the deviations in plastic temperature, which results in extreme deviations in quality. This adverse process behavior caused by the different temperatures of the preforms is especially serious in complex plastic containers. These disadvantages can be diminished by the compensation measures described above.

It is also possible to control and regulate the blowing process separately for each preform subgroup in order to compensate the thermal differences in the preforms transferred to the blow station, for example by pairs. This can be achieved by using a pyrometer to measure the temperature of each preform subgroup prior to transfer to the blow station, and activating the temperature measurement to vary the blow process parameters. Moreover, the necessary blow process parameters can also be changed in stages in accordance with a defined strategy for each preform subgroup.

The targeted influencing of the blow process parameters involved has the result that each preform subgroup, e.g. pair of preforms, is blow molded into high quality plastic containers. Active control of the blow process parameters for each subgroup of the preforms can be accomplished by computer control in conjunction with the temperature measurement described above or with a defined strategy.

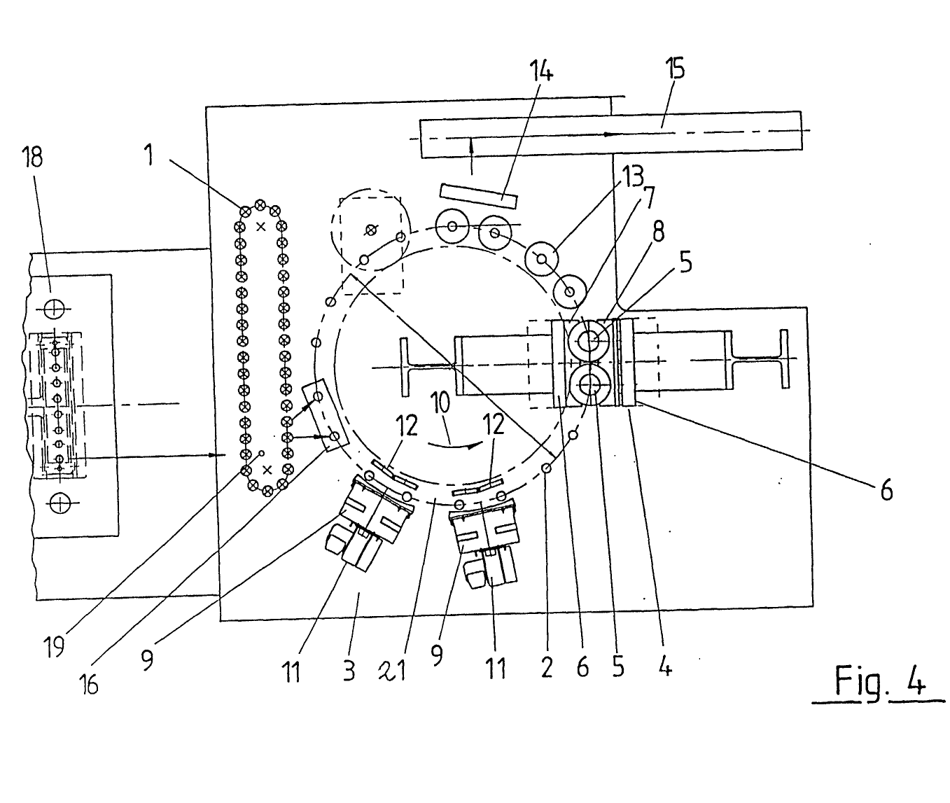

In the embodiment shown in FIG. 4 of a device for performing the one-stage container manufacture process, the device for blow molding of containers has a transport wheel (21) which has a ring-like construction. The transport wheel (21) is arranged such that it can rotate and has holder devices (2) along its circumference. Arranged along the transport wheel (21) are a heater unit (3) and a blow station (4). In the embodiment depicted, the blow station (4) has two cavities (5), although the concept includes, in particular, the use of three or more cavities. Four cavities are provided in a typical size.

The blow station (4) consists of mold supports (6) which hold blow mold parts (7, 8). The mold supports (6) can be positioned relative to one another in order to permit opening and closing of the blow station.

The heater unit (3) consists of heating boxes (9) that are arranged one behind the other in a direction of transport (10). The heating boxes (9) may be open or tunnel-like in design. In one typical embodiment, the heating boxes (9) have infrared radiators and cooling fans (11). Reflectors (12) may be arranged opposite the heating boxes (9).

The finished, blow molded containers (13) are transferred by the transport wheel (21) to an output device (15) in the vicinity of a discharge (14). The preforms (1) are delivered to the transport wheel (21) in the vicinity of an inlet (16).

In the case of a combination blow unit and injection unit (18) as a single device for the one-stage process, it is particularly advantageous to use temporary storage (19) for the preforms (1). The temporary storage (19) performs coordination of different cycle times of the injection unit (18) and blow unit, and temperature treatment of the preforms (1) is also possible. With regard to handling of the preforms (1) and the containers (13), the concept particularly includes intermittent (cycled) operation of the device components described.

1. A process for controlling the molding of a container during the manufacture of containers from a thermoplastic material, in which at least two injection-molded preforms are temperature-treated and delivered in succession to at least one blow station for blow molding of the preforms into containers, characterized in that, in order to compensate for nonuniform heat content in the material of the preforms (1) relative to one another, at least one blow parameter during molding of the preforms (1) into containers (13) is specified in a fashion that differs among them in such a manner as to compensate for the nonuniform heat content such that containers (13) with approximately identical spatial distribution of wall material, orientation properties, and crystallization characteristics exist when the blow-molding process is finished.

2. A process in accordance with claim 1, characterized in that the blow molding is performed as a sequence of an initial preblow phase followed by a primary blow phase, wherein a higher blow pressure is achieved during the primary blow phase than is reached during the preblow phase, and in that the pressure profile is varied as a blow parameter.

3. A process in accordance with claim 2, characterized in that the duration of the preblow phase is varied as a blow parameter.

4. A process in accordance with claim 2, characterized in that the duration of the primary blow phase is varied as a blow parameter.

5. A process in accordance with claim 2, characterized in that the time of switchover between the preblow phase and the primary blow phase is varied as a blow parameter.

6. A process in accordance with claim 1, characterized in that a stretching rate is varied as a blow parameter.

7. A process in accordance with claim 1, characterized in that a start time of the stretching process is varied as a blow parameter.

8. A process in accordance with claim 1, characterized in that differing thermal treatment of successive preforms is carried out in such a manner that an approximately identical temperature distribution is present in the preforms despite the differences among the individual preforms in the waiting period prior to blow molding and/or prior to a heating phase preceding blow molding.

9. A process in accordance with claim 1, characterized in that essentially identical thermal treatment of the successive preforms is carried out initially and in that this identical thermal treatment is followed by an additional thermal treatment that approximately compensates for the differences in waiting period among the individual preforms prior to the start of subsequent blow molding.

10. A process in accordance with claim 9 characterized in that an application is carried out in one-stage manufacture of containers.

11. A process in accordance with claim 10, characterized in that N preforms are first produced simultaneously by injection molding, and then X×M preforms are simultaneously molded into containers, where X×M=N.

12. A process in accordance with claim 1, characterized in that control of the change in at least one blow parameter is performed as a function of measurement of at least one property of the preforms.

13. A device for blow molding of containers from a thermoplastic material that has a temperature treatment unit for injection-molded preforms, at least one stretching unit for the preforms, and also has at least one blow station for molding the preforms into containers, characterized in that parameter control is provided which specifies at least one of the parameters influencing the molding process differently from one preform to the next for at least two preforms processed in succession.

14. A device in accordance with claim 13, characterized in that the parameter control is designed as control for a blow pressure sequence.

15. A device in accordance with claim 13, characterized in that the parameter control is designed as control for the stretching process.

16. A device in accordance with claim 13, characterized in that the parameter control is designed as control for specifying a temperature profile in the preforms.

17. A device in accordance with claim 14, characterized in that the parameter control is designed as control for the stretching process.

18. A device in accordance with claim 14, characterized in that the parameter control is designed as control for specifying a temperature profile in the preforms.

19. A device in accordance with claim 15, characterized in that the parameter control is designed as control for specifying a temperature profile in the preforms.
